(19) United States
(12) Patent Application Publication
(10) Pub. No.: US 2013/0143173 A1
(43) Pub. Date: Jun. 6, 2013

(54) FURNACES, PARTS THEREOF, AND METHODS OF MAKING SAME

(71) Applicant: MORGAN ADVANCED MATERIALS AND TECHNOLOGY INC., ST. MARYS, PA (US)

(72) Inventors: ANDREW JOSEPH GOSHE, Fostoria, OH (US); SANDY LEE ZEIGLER, Fostoria, OH (US); MATTHEW PHILLIP CORIATY, Coudersport, PA (US); ANTHONY WILLIAM COCHRAN, Coudersport, PA (US); ROBERT DONALD STILES, Coudersport, PA (US)

(73) Assignee: MORGAN ADVANCED MATERIALS AND TECHNOLOGY INC., ST MARYS, PA (US)

(21) Appl. No.: 13/659,970

(22) Filed: Oct. 25, 2012

Related U.S. Application Data
(60) Provisional application No. 61/554,543, filed on Nov. 2, 2011.

(51) Int. Cl. F27D 1/00; F27B 14/12; F27D 7/06

(52) U.S. Cl. CPC F27D 1/0033; F27D 7/06; F27B 14/12
USPC 432/248; 432/249; 373/112; 264/30

(57) ABSTRACT

A furnace comprises a cage holding and supporting an insulation pack comprising one or more base boards, one or more top boards and a plurality of side boards each of rigid carbon fiber based insulation material, the one or more base boards, one or more top boards, and plurality of side boards defining a cavity between them. A flexible carbon felt is disposed between the side boards and the cage.

### CROSS-REFERENCE TO RELATED APPLICATIONS

This application claims the benefit of (1) U.S. Provisional Application No. 61/554,543 filed on Nov. 2, 2011, titled “Furnaces, Parts Thereof, and Methods of Making Same,” (2) Chinese Patent Application No. 201220452716.1 filed on Sep. 6, 2012; (3) Taiwan Patent Application No. 101213629 filed on Jul. 13, 2012; and (4) German Patent Application No. 202012007524.1 filed on Aug. 2, 2012, the entire contents of each of which are incorporated herein by reference.

### FIELD OF INVENTION

Embodiments of this invention relate to furnaces, parts thereof, and methods of making such furnaces and parts.

### BACKGROUND

A solar (photovoltaic) cell is a device that is capable of converting electromagnetic radiation, light, into electricity by the photovoltaic effect.

Photovoltaic materials that have been used in solar cells include: crystalline and amorphous silicon, compound semiconductors, organic dyes and polymers, and nanocrystals commonly referred to as quantum dots. Among these photovoltaic materials, crystalline silicon, c-Si, is by far the most prevalent material.

c-Si is generally produced as large ingots of material that are shaped and sliced into individual wafers. There are two formats for c-Si materials, monocrystalline and multicrystalline. Monocrystalline silicon is a single crystal of silicon with no grain boundaries. Multicrystalline silicon is comprised of multiple crystals of silicon with a grain boundary between each silicon crystals. The production of c-Si requires substantial energy to affect the heating and melting of the silicon.

Monocrystalline silicon is produced in rounded ingots of material often using the Czochralski process. In the Czochralski process, silicon is melted in a furnace, a single crystal seed is dipped into the surface of the molten silicon, the seed is slowly withdrawn from the melt while rotating, as the seed is withdrawn the temperature is controlled such that crystal growth results. Through control of the rotation speed, the rate of withdrawal of the seed crystal, and the temperature gradients present in the furnace, it is possible to produce large, cylindrical, single crystals of silicon. Monocrystalline silicon has the advantage of greater conversion efficiency of solar light into electrical energy. Monocrystalline silicon, however, does not efficiently use the cast silicon ingot since the cylindrical ingots must be cut into roughly square ingots prior to be wafering.

Multicrystalline silicon is produced as square or rectangular ingots of material. In the multicrystalline process, silicon is melted in a furnace, a temperature gradient is created in the furnace and the silicon recrystallizes from one end of the crucible to the other (typically the bottom to the top). The result is a multicrystalline ingot. The grain sizes in the ingot are typically millimeter to centimeter in width and grow in an approximately columnar arrangement from the bottom of the crucible to the top. The process of crystallization is referred to as directional solidification (DS) and furnaces for multicrystalline silicon growth are referred to as directional solidification systems (DSS furnaces). The ingot sizes in DS are sized as whole multiples of the wafer length and width, permitting efficient use of the material. The multicrystalline wafers, however, are not as efficient as monocrystalline wafers in their conversion of light into electrical energy. There are several variants of DSS furnaces including DSS furnaces modified to produce quasi-monocrystalline ingots and gradient controlled crystallization furnaces.

FIG. 1 shows a typical vacuum furnace designed for casting of multicrystalline or monocrystalline ingots of a material. For photovoltaic applications, the material is typically silicon, generally cast as a multicrystalline ingot. Regardless of the manufacturer of the furnace, the general design principles of the furnace are common. A water cooled furnace shell 1, typically constructed from steel, surrounds a cage 2, generally constructed from stainless steel. The cage 2 holds and supports an insulation pack 3. The insulation pack 3 both reduces the amount of energy required to heat and maintain the core of the furnace at high temperature and protects the furnace shell 1 from temperatures that are capable of melting or recrystallizing the shell materials.

Interior to the insulation pack 3 are heating elements 4. Most such furnaces are heated by graphite resistance heating elements where the graphite is connected to a power supply, current is passed through the graphite, and the resistance of the graphite to the flow of electrical current generates heat. It is possible to employ other heating methods including induction heating.

Interior to the insulation pack 3 and heating elements 4 is a cavity 5 containing a crucible 6 that contains the material 7 [e.g. silicon] being melted or recrystallised, and other graphite parts that surround or support the crucible. The heating elements 4 and cavity 5 together define the “hot zone” to the furnace that is insulated by the insulation pack 3. The crucibles 6 are typically constructed from fused silica, but other materials may also be employed. Manufacturers of DSS furnaces include: ALD Vacuum Technologies, Centrotherm, Ferrotec, GT Advanced Technologies (formerly GT Solar), Jinggong, JYT, Kayex, PVA TePla, Roth & Rau Zhejian Jingsheng Mechanical & Electrical Co., and others.

Reduction of the energy used to produced c-Si is a key goal for users of such furnaces as energy demand continues to increase in all markets.

Typically, insulation packs in such furnaces consist of a series of parts that, once assembled, form a roughly cube-shaped insulation pack. The material used for the individual insulation components is typically a low density composite of carbon fiber and a carbonized resin. The insulation material is typically rigid board, a short-fiber composite made by resin impregnation of chopped carbon fiber, or rigidified board, a long-fiber composite manufactured by resin impregnation of carbon or graphite felt. Examples of commercially available rigid board include: Morgan Advanced Materials and Technology Rigid Board, Americarb CFB-17 Rigid Fiberboard Insulation, Mersen CBCF Rigid Carbon Insulation, GrafTech GRAFSHIELD GRI Thermal Insulation, and others. Examples of commercially available rigidified board include Kureha KRECA FR, SGL Group SIGRATHERM Rigid Graphite Felt, and others. In the following, both rigid and rigidified board will be referred to as rigid carbon fiber based insulation material.

Rigid carbon fiber based insulation materials have several deficiencies.

First, the incorporation of a carbonized resin into the insulation matrix raises the thermal conductivity of the material, making it less insulating.

Second, the insulation materials have an inherent grain structure in that the fibers of the board are preferentially aligned parallel to the board surface, and preferentially not aligned parallel to the thickness of the board. The degree of alignment varies from material to material and the grain structure generally reflects a tendency to alignment rather than strict alignment. The result is that these materials have grossly different insulation properties when heat flow operates against the thickness of the board than when the heat flow operates along the length and width of the board. In the current application, the result of this differential insulation value is a corner anomaly that disrupts standard heat flow and may result in imperfections in the ingot as it is grown.

Third, the rigid carbon fiber based insulation materials are prone to warp and other distortion during the lifetime over which they are used. The warp of the insulation results in gaps forming between parts, allowing heat to short circuit the insulation.

Finally, as furnaces age, the cages are prone to distortion and warp. The installation of rigid carbon fiber based insulation materials into warped cages becomes impossible and the cages must be replaced.

The design of the insulation packs presently used in DSS applications is that the insulation parts are machined boards of rigid carbon fiber based insulation material. The mating between pieces is generally achieved via a simple butt-joint between parts (FIG. 2).

Butt joints between insulation parts have the deficiency that each butt joint 8 provides a pathway for heat transfer, a “thermal short circuit”, that reduces the overall insulation value of the system, and increases the energy requirement during operation. Thermal short circuiting can also lead to the possibility of “shine-through”, a dangerous condition whereby the light energy from the furnace hot zone shines directly on the outer shell. The heat transferred to the shell is capable of causing a furnace explosion. Additionally, the butt joint provides no reinforcement to limit the effect of the previously described warp and distortion of rigid carbon fiber based insulation materials.

Finally, the corners of the insulation pack are not uniform in insulation thickness compared to the walls of the insulation pack. In an assembly of side boards 9 as illustrated in FIG. 3 the thickness through the corner 10 is approximately 70% of the thickness of the wall: in an assembly of side boards 9 as illustrated in FIG. 4, the thickness through the corner 11 is approximately 140% of the wall thickness. This means that the resistance to the flow of heat from a source 12 [e.g. a crucible 5] in directions 13 is different from the resistance to the flow of heat in directions 14, leading to an uneven distribution of heat within heats source 12.

The combined result of these deficiencies of prior art constructions are elevated energy use and reduced ingot quality.

To overcome the aforementioned deficiencies, a new furnace design has been conceived in which a flexible carbon felt is disposed between the side boards and the cage.

### BRIEF DESCRIPTION OF THE DRAWINGS

The scope of the invention is as set out in the appended claims in the light of following illustrative but non-limiting description and with reference to the drawings in which:

FIG. 1 is a schematic view of a prior art vacuum furnace;

FIG. 2 is a schematic detail of a conventional manner of joining panels end-to-end;

FIGS. 3 and 4 are schematic detail of a conventional manner of joining panels at a corner;

FIG. 5 is a schematic detail analogous to FIGS. 2 and 4 showing a corner detail of insulation from one embodiment of the present invention;

FIG. 6 is an orthogonal view of a bottom cage and insulation pack from a furnace in accordance with the present invention;

FIG. 7 is an inverted orthogonal view of a top cage complementary to the bottom of FIG. 6;

FIG. 8 is a sectional view of a cage comprising the bottom cage of FIG. 6 and the top cage of FIG. 7;

FIG. 9 is a schematic showing connection features for portions of the insulation pack of the invention;

FIGS. 10 and 11 are assembly drawings for a cage and insulation pack as shown in FIGS. 6-8;

FIG. 12 is shows typical thermal conductivity of Morgan Rigid Board and Morgan Carbon Felt.

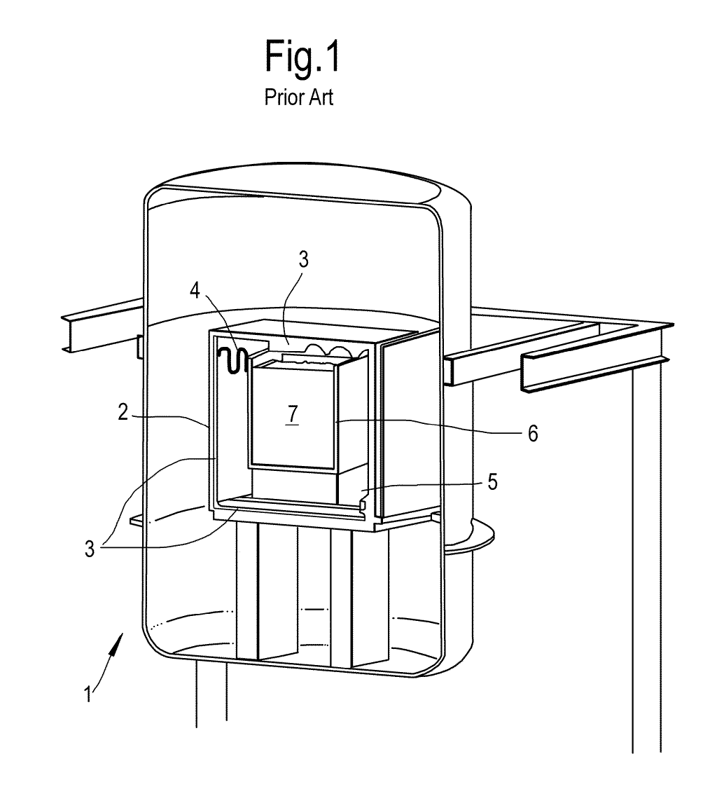

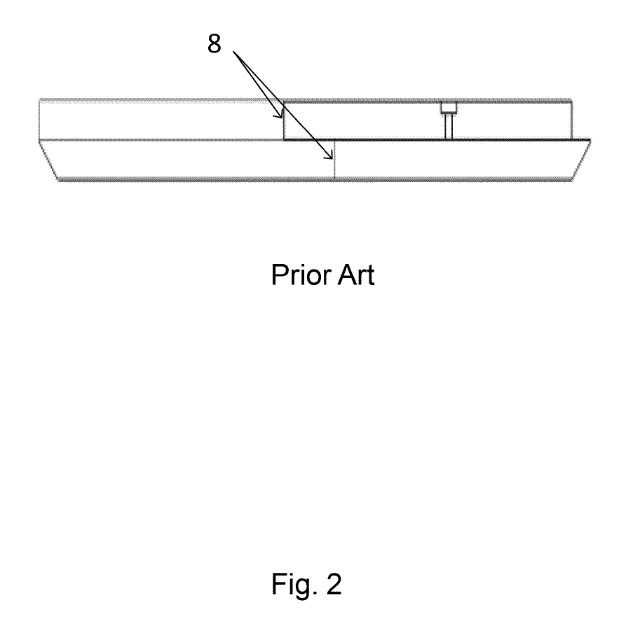

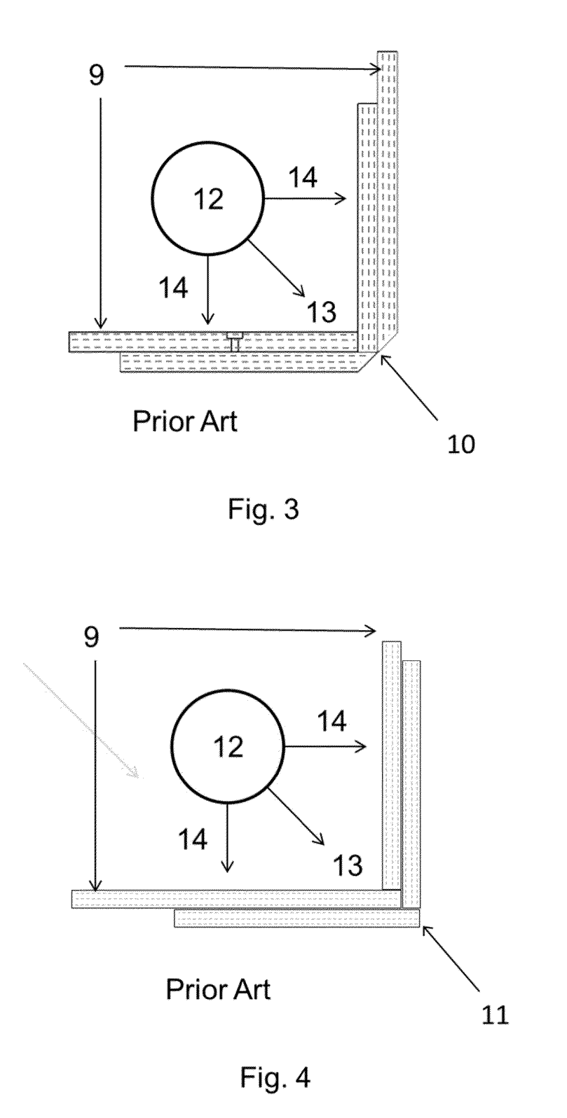

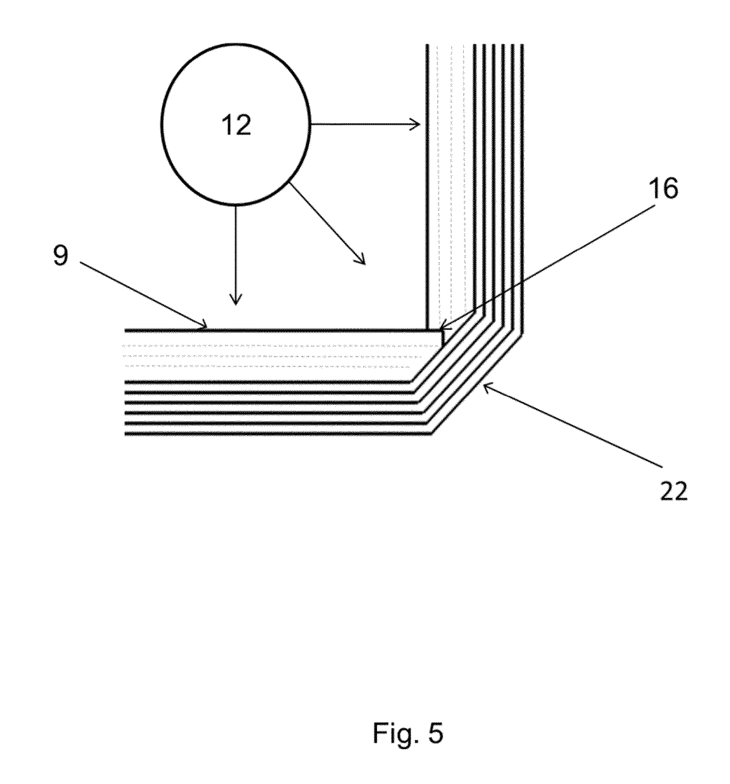

### DETAILED DESCRIPTION

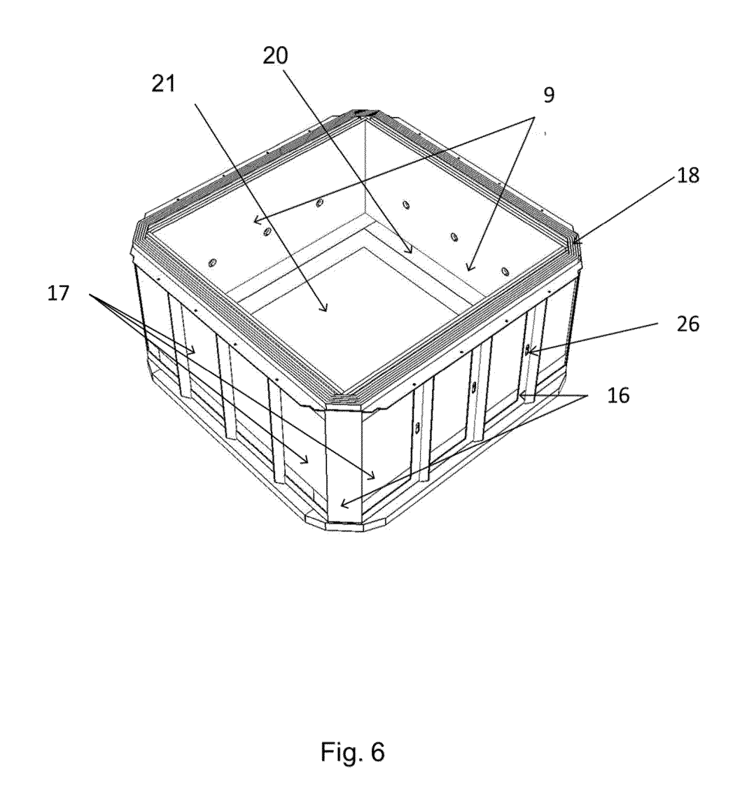

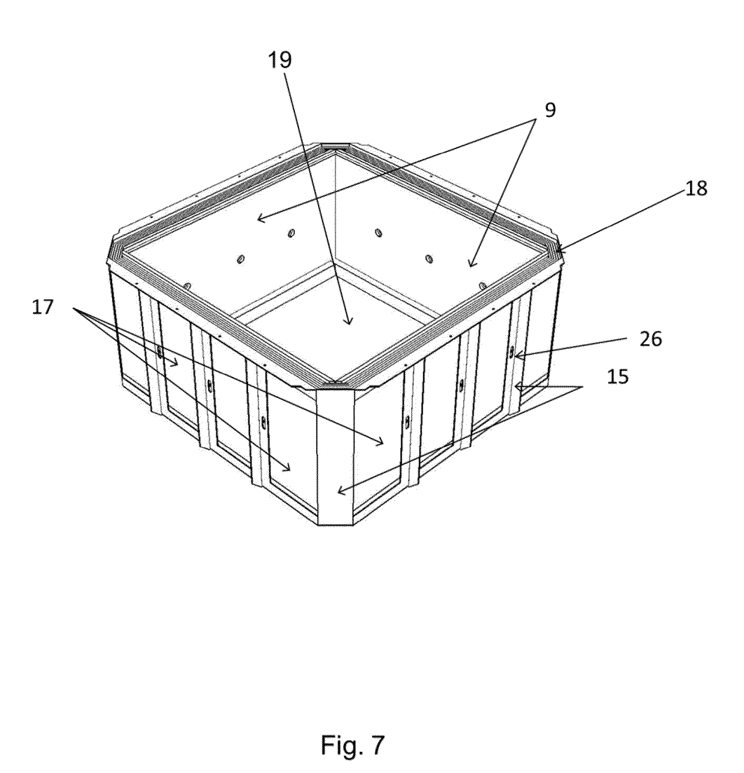

A typical insulation pack in accordance with the present invention is indicated schematically in part in FIG. 5 and as orthogonal and sectional views in FIGS. 6, 7 and 8. In FIGS. 6, 7, and 8 a cage comprises an upper cage 15 and lower cage 16. Lining the side walls of the upper cage 15 and lower cage 16 is a graphite foil outer layer 17. Interior to, and protected by, the graphite foil outer layer 17 is a layer 18 of a flexible carbon felt. The graphite foil outer layer is optional. The graphite foil outer layer protects the carbon felt from chemical degradation, for example caused by silicon-containing vapor attack on the material. Interior to the layer 18 of a flexible carbon felt are side boards 9 of a rigid carbon fiber based insulation material. The side boards 9 may optionally be coated with graphite foil or graphite paint to reduce the susceptibility of the material to degradation caused by the silicon-containing vapor. This arrangement is implemented on all four sides of the insulation pack.

Top boards 19 typically comprise boards of rigid carbon fiber based insulation material sandwiching flexible carbon felt. The bottom of the insulation pack comprises an assembly of edge boards 20 and a center board 21. Although only a single center board is shown, it is possible to use multiple boards. Equally it is possible to use a single board in place of the edge boards 20 and center board 21 although separate provision of edge and center boards has the advantages that separate edge and center boards (20,21) permit a degree of relative movement such that the base can accommodate distortions in the cage. Further, the edge boards 20 can be machined permitting a plain unmachined board to provide the center board 21.

Typically, the edge boards 20 and center board 21 or equivalent are formed of rigid carbon fiber based insulation material.

Dependent on application, other constructions are possible, for example, by providing additional carbon felt insulation to the bottom of the insulation pack.

A key feature of the new insulation pack design is the incorporation of flexible carbon felt as a replacement for the outermost insulation material conventionally provided on the sides of the insulation pack.

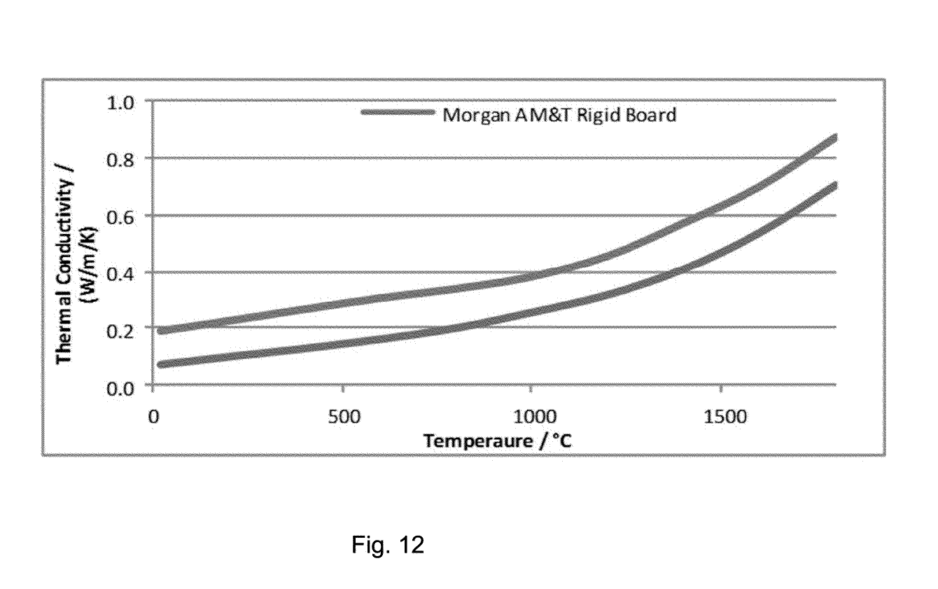

Carbon felt has a lower thermal conductivity (lower curve in FIG. 12) than rigid carbon fiber based insulation material (upper curve in FIG. 12). Therefore, its incorporation into the design of the insulation pack can reduce the energy requirement dramatically.

Secondly, the incorporation of carbon felt into the design permits the insulation to mitigate differential heat flow between the walls and the corners of the insulation pack. This may be accomplished by wrapping the felt insulation around the interior of the insulation cage. The wrap of felt around the corners of the insulation cage improves the thermal uniformity of the hot-zone and may lead to an improvement in the quality of the ingot produced. It is not necessary for a continuous layer of felt to be provided [overlapping sections of felt can be used] however a continuous length of felt has the advantage of providing few junctions where heat may escape and reducing the risk of movement of the felt opening up gaps between sections of felt. Provision of at least one continuous layer of flexible carbon felt wrapped around at least some of the side boards to overlap itself reduces the risk inherent in using sections of carbon felt.

Carbon felt is typically produced with a large aspect ratio. The typical length of a roll of felt is approximately fifteen meters and the width is less than one meter. The large aspect ratio lends itself to continuous wrapping of the layers of felt material providing a seamless insulation body for the insulation pack.

A second feature of the new design is the incorporation of design features that prevent a direct path for heat flow from the hot-face of the insulation to the cold-face.

This is accomplished in two manners. First, the overall number of board parts has been reduced in comparison with conventional designs, reducing the number of potential paths for heat to escape. Second, features have been designed into the junction of each piece of rigid insulation to serve two purposes, firstly to create a non-linear path from the hot-face of the insulation to the cold-face; and secondly to provide optional interengagement and optional interlocking of the board parts.

As can be seen in FIG. 5, edge portions of boards 9 have complementary engagement features to provide a junction 16 between the boards 9 giving a non-linear path. This non-linear path from the furnace cavity to the exterior of the insulation mitigates the risk of heat transfer through the junction

Similarly, a non-linear path from the hot-face of the insulation to the cold-face can be provided:
at the joint area between the top and side boards and the bottom and side boards
between side board pieces

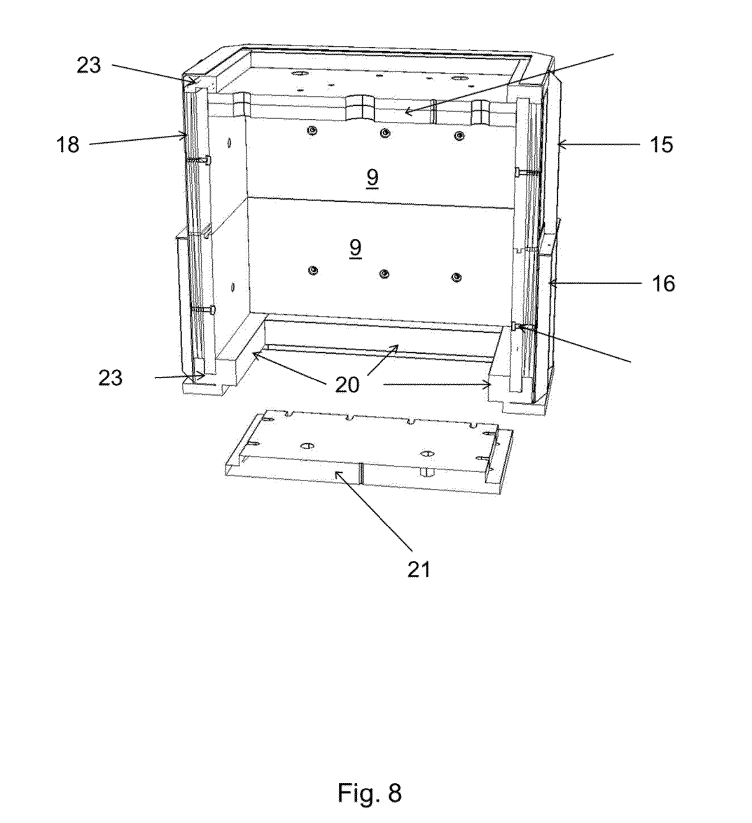

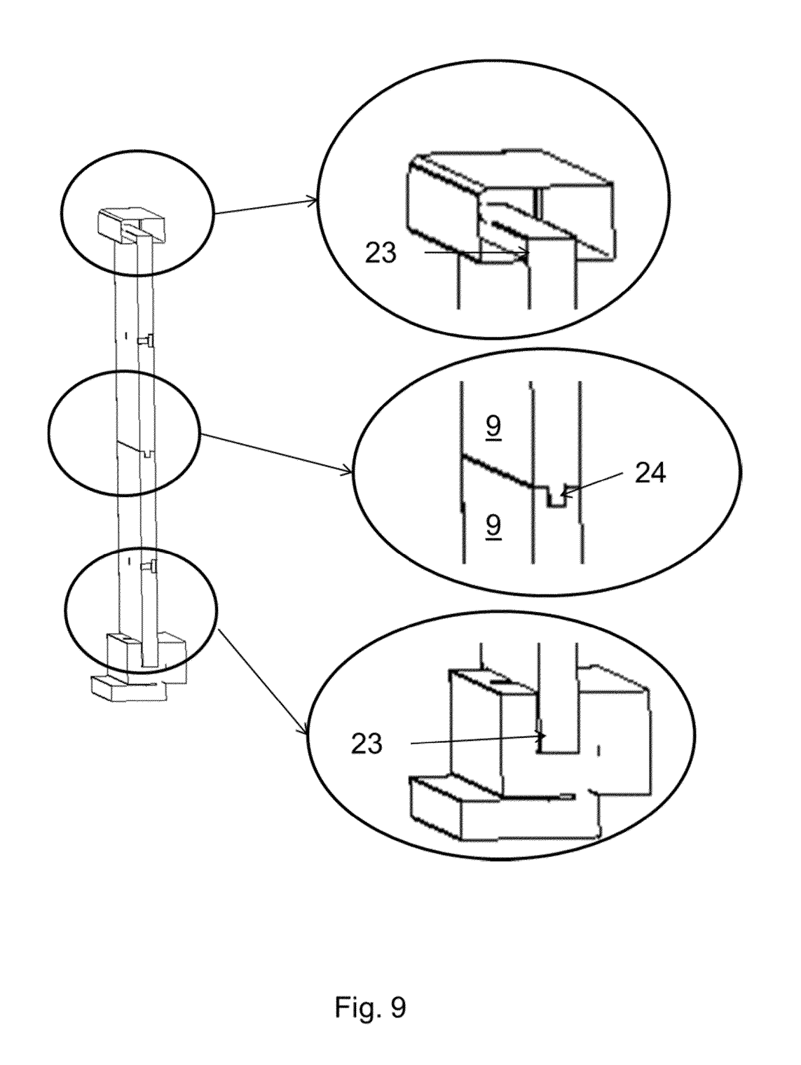

As seen in FIG. 8, and in more detail in FIG. 9, the joint area between the top and side boards and the bottom and side boards can be provided by dado joints 23 comprising a groove in the respective top or bottom board receiving an edge of the side board 9. Similarly, a tongue-and-groove joint 24 may be used between side board pieces by shaping the edges of the side board pieces 9.

The joints indicated are illustrative and other joints can be used, the principal features of the illustrated joints are the provision of non-linear paths path from the hot-face of the insulation to the cold-face. Other constructions that can assist in this purpose are illustrated in WO2011/106580.

Bolt holes 25 through the side boards 9 and corresponding bolt holes 26 in the cages can receive bolts (not shown) to secure to the side boards to the bolt holes. The bolts may be of a carbon composite material.

As a result of the design, it is difficult for the boards of rigid carbon fiber based insulation material to deform in use. The selection of the joints at each interface between parts provides reinforcement that mitigates or negates warp. For example, the dado joints between the top and sides and the bottom and sides lock the side boards into position. Similarly, the tongue-and groove joint between the side boards positively locks the boards together, eliminating the possibility of warp. Finally, the joint construction between the corners of the side boards provides a similar locking feature.

The insulation pack may be assembled separately in the top and bottom portions of the cage as shown in FIGS. 6, and 7 and later mated in the furnace as in FIG. 8, or they may be assembled as a whole unit.

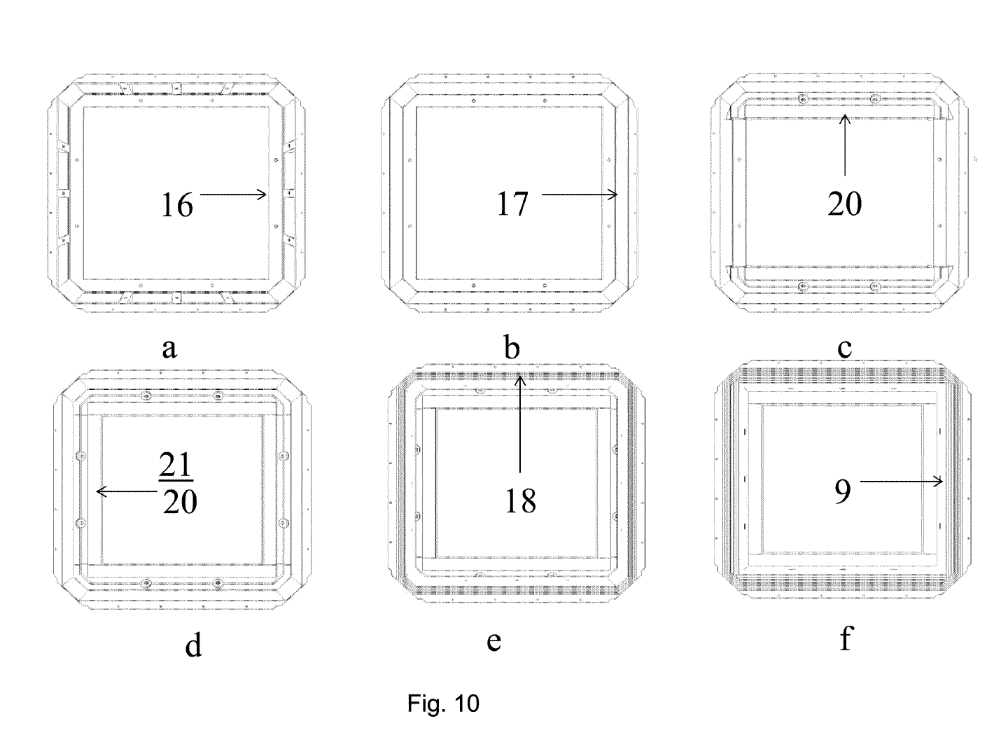

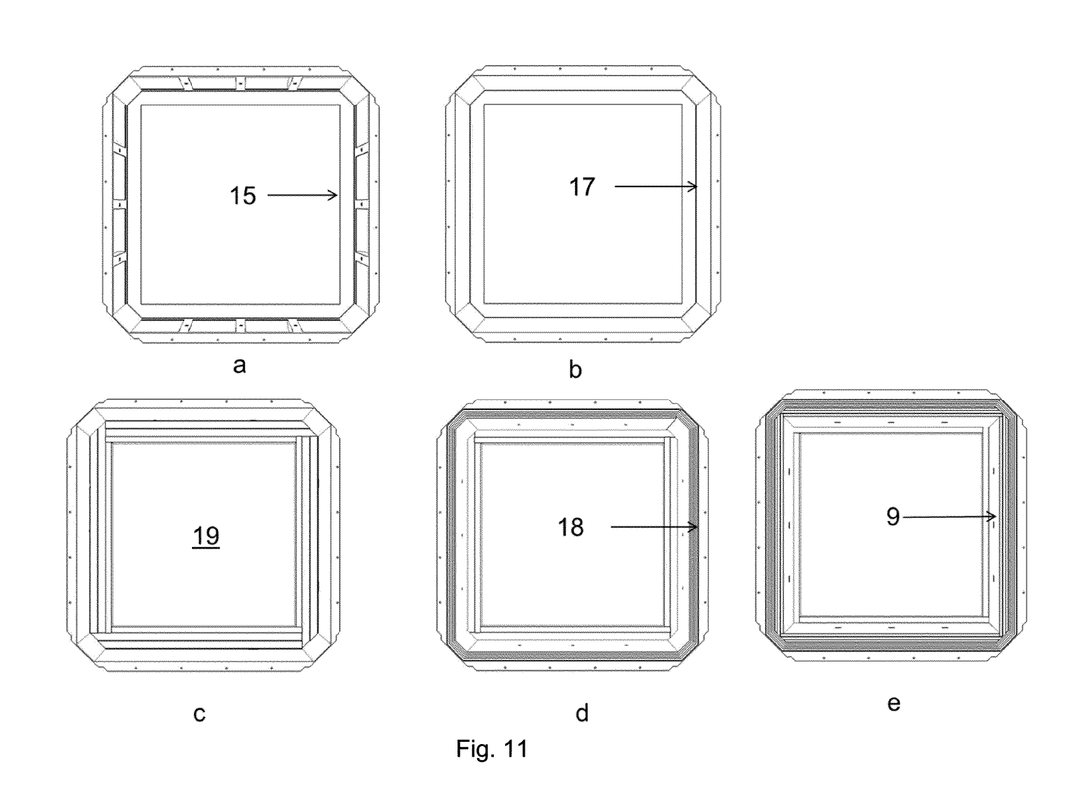

To manufacture a furnace cage and insulation pack in accordance with FIGS. 6-8, the top and bottom segments of the insulation pack are assembled separately. FIG. 10 shows a typical assembly sequence a-f for the bottom segment and FIG. 11 shows a typical assembly sequence a-e for the top segment.

The upper cage 15 and bottom cage 16 may be cleaned to be free of surface debris. An appropriate adhesive may be sprayed onto the interior side walls of the cage. Examples of an appropriate adhesive include 3M Super 77 and Barnes Distribution Web Tite Adhesive. Sheets of graphite foil 17, pre-cut to the dimensions of the wall of the cage segment, are installed onto the interior of the cage with the spray adhesive, if present, serving to hold the pieces in place. Examples of a suitable graphite foil include GrafTech GRAFOIL GTA and SGL Group SIGRAFLEX C. The thickness for the graphite foil should be greater than 0.005″ (0.127 mm) and is preferable at least 0.0601-1.52 mm).

The bottom edge boards 20, 21 may be installed into the bottom furnace cage 16 and the top insulation parts 19 may be installed into the top furnace cage 15. The bottom and top boards 20, 21, 19 are typically machined from a rigid insulation material, such as Morgan AM&T rigid board.

A thin, intermittent layer of adhesive may be placed on the interior surface of the graphite foil sheet 17. Starting at one of the corners, the flexible carbon felt 18 is adhered to the graphite foil 17 and pressed to the sides of the respective cage. To enable the wrap to continue, the spray adhesive may be applied to the interior surface of each concentric layer of carbon felt wrap 18. The carbon felt wrap 18 is continued in a concentric, continuous manner with one or more pieces of carbon felt until the desired thickness is achieved. The thickness of the felt material is ideally within +/−5 mm of the rigid insulation that it is replacing, but can be outside this limit. For example, if the carbon felt is replacing 45 mm of a rigid insulation, a suitable thickness is between 40 mm and 50 mm. Suitable carbon felt materials include Morgan AM&T VDG carbon felt and Morgan AM&T WDF graphite felt. The side insulation boards 9 are installed into their respective cage half. The side insulation boards 9 are a rigid insulation material, Morgan AM&T rigid board, for example. The side boards 9 lock into position in the receiving dado joint 23 located on the top and bottom boards. The top and bottom cages 15,16 with the insulation are then installed in the furnace. The top board 19 is typically constructed from two pieces of machined rigid board that sandwich carbon felt. The bottom boards 20, 21 are machined rigid board.

The above description is for illustrative purposes and variant and alternatives will be evident to the person skilled in the art and are encompassed herein to the extent covered by the claims.

What is claimed is:

1. A furnace comprising a cage holding and supporting an insulation pack comprising one or more base boards, one or more top boards and a plurality of side boards each of rigid carbon fiber based insulation material, the one or more base boards, one or more top boards, and plurality of side boards defining a cavity between them, characterized in that a flexible carbon felt is disposed between the side boards and the cage.

2. The furnace as claimed in claim 1, in which the cage comprises an upper portion and a lower portion, the upper portion housing the one or more top boards and a plurality of side boards, and the lower portion housing the one or more base boards and a plurality of side boards.

3. The furnace as claimed in claim 1, in which the flexible carbon felt comprises at least one continuous layer of flexible carbon felt wrapped around at least some of the side boards to overlap itself.

4. The furnace as claimed in claim 1, in which sheets of graphite foil are disposed between the cage and the flexible carbon felt.

5. The furnace as claimed in claim 1, in which one or more sides of one or more of the one or more base boards, one or more top boards, and plurality of side boards is coated with graphite foil.

6. The furnace as claimed in claim 1, in which one or more sides of one or more of the one or more base boards, one or more top boards, and plurality of side boards is coated with graphite paint.

7. The furnace as claimed in claim 1, in which some at least of the one or more base boards, one or more top boards and plurality of side boards comprise one or more engagement features engaged with one or more complementary engagement features on at least one adjacent base board, top board or side board to provide a non-linear path from the cavity to the exterior of the insulation.

8. The furnace as claimed in claim 7, in which at least one engagement feature comprises a channel and the complementary engagement feature comprises a part of said at least one adjacent base board, top board or side board received within the channel.

9. The furnace as claimed in claim 7 in which one or both of the one engagement feature and complementary engagement feature extends along an entire edge of the respective board.

10. The furnace as claimed in claim 1, in which the flexible carbon based felt is a flexible graphite felt.

11. The furnace as claimed in claim 1, which is a vacuum furnace.

12. An assembly of a cage and insulation pack suitable for use in a furnace as claimed in claim 1.

13. An insulation pack comprising:
one or more base boards, one or more top boards and a plurality of side boards each of rigid carbon fiber based insulation material;
a flexible carbon felt;
the kit being adapted to form, in conjunction with a cage, an assembly of a cage and insulation pack as claimed in claim 12.

14. A method of making an assembly of a cage and insulation pack as claimed in claim 12 comprising the steps of:
lining interior sides of the cage with graphite foil
applying adhesive to interior sides of the graphite foil
lining the interior sides of the graphite foil with the flexible carbon felt
assembling the one or more base boards, one or more top boards and plurality of side boards interior of the flexible carbon felt.
